(19) United States
(12) Patent Application Publication
(10) Pub. No.: US 2007/0149723 A1
(43) Pub. Date: Jun. 28, 2007

(54) Silicone-containing graft copolymers based on styrene oxide-based silicone polyethers

(75) Inventor: Peter Schwab, Essen (DE)

Correspondence Address: Leopold Presser, Scully, Scott, Murphy & Presser, 400 Garden City Plaza, Garden City, NY, 11530, US

(73) Assignee: Goldschmidt GmbH, Essen (DE)

(21) Appl. No.: 11/604,405

(22) Filed: Nov. 27, 2006

(30) Foreign Application Priority Data
Dec. 23, 2005 (DE) 10 2005 061 782.4

(51) Int. Cl. C08L 83/04; C08G 77/04; B01D 19/04; B01D 19/00

(52) U.S. Cl. 525/479; 528/25; 95/242

(57) ABSTRACT

The invention relates to silicone-containing graft copolymers and to processes for their preparation. In particular, the invention relates to silicone-containing graft copolymers which are obtained by the controlled grafting of olefinic monomers onto a partly styrene oxide-based silicone polyether.

### FIELD OF THE INVENTION

The present invention relates to silicone-containing graft copolymers and to processes for their preparation. In particular, the present invention relates to silicone-containing graft copolymers which are obtained by the controlled grafting of olefinic monomers onto a partly styrene oxide-based silicone polyether.

### BACKGROUND OF THE INVENTION

In the last few decades, industrially obtained silicones have become a significant and varied product group which plays an important role in almost all industrial sectors and is notable for constant growth. Particularly, the organically modified silicones have, by virtue of their various possible configurations, contributed to the enabling of a great multitude of product types and hence the development of a multitude of applications.

Owing to the great economic significance, a series of methods have been developed to prepare such organically modified siloxanes. For this purpose, a linkage of free-radical polymerization and silicone chemistry is desirable from many points of view. The advantages of free-radical polymerization reside in the multitude of usable monomers which are also available on the industrial scale, the high tolerance toward functional groups including carboxyl, hydroxyl, amino and epoxy functions, the relatively low level of experimental complexity, and the mild and insensitive reaction conditions. However, the direct grafting of organic olefins onto dialkylsiloxanes, in spite of the description provided in the literature, is very unfavorable from a thermodynamic point of view and owing to lack of compatibility, leads predominantly to the formation of homopolymers without chemical bonding to the siloxane backbone. Polyether-modified silicones are suitable graft bases, since the ether groups can be attacked considerably more easily by free radicals. Thus, free radicals can be generated by hydrogen abstraction on ethylene oxide (EO)- and, even better, propylene oxide (PO)-containing silicone polyethers, and a polymer chain can be grafted from them by addition to the corresponding vinylic monomers. This is described, for example, in DE 1645569 A. Even though both PO and EO fractions are present in the polyalkylene oxide chain, a very low selectivity is achieved in the process. In many cases, though, it is of particular importance to exert a certain control over the graft sites and hence the topology of the macromolecule. By virtue of the more specific structure of the macromolecule, it is possible to actually achieve or improve important properties for certain applications.

In view of the above, there is a need for providing the controlled grafting of a silicone polyether which avoids the drawbacks mentioned herein above.

### SUMMARY OF THE INVENTION

The present invention enables controlled grafting of a silicone polyether by utilizing polyether chains having benzylic C—H bonds. Specifically, it has now been found that the use of polyethers formed partly from styrene oxide has the consequence of sufficiently controllable selectivity.

The grafted polyether siloxanes thus prepared are suitable for a wide variety of different applications in which organically modified polyether siloxanes are used. The grafted polyether siloxanes may have significant improvements in properties over randomly grafted polyether siloxanes. The comparison with randomly grafted polyether siloxanes, whose polyethers are formed only from ethylene oxide and propylene oxide, show a distinct improvement in the long-term effectiveness as defoamers and deaerators for nonaqueous systems based on mineral oils or synthetic oils.

In accordance with the present invention, below 150 ppm, preferably between 10 and 100 ppm of the inventive copolymer is added to a nonaqueous system that includes one of a mineral oil or a synthetic oil.

In the oil sector, the advantageous properties of the inventive polymers lead to the desired property combination of defoamer and deaerator, which remains stable over months and thus achieves the basic prerequisite for use in engines and machines.

### DETAILED DESCRIPTION OF THE INVENTION

The present invention which provides for the controlled grafting of a silicone polyether by utilizing polyether chains having benzylic C—H bonds will now be described in greater detail.

The silicone polyethers used to prepare the inventive copolymers include all compounds which consist of a silicone moiety and a polyether moiety which bears at least one styrene oxide unit as a chain constituent, and in which no hydrogen atoms bonded to silicon are present.

Polyether siloxanes suitable as the graft base are siloxanes which contain groups of the formula (V):

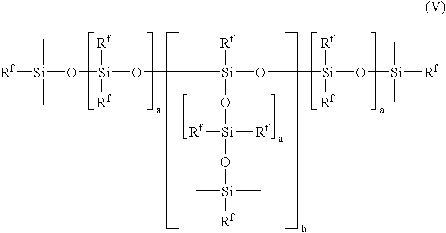

wherein
R^{f} may be an R¹ radical, and
R¹ is an alkyl radical having from 1 to 16 carbon atoms or an aryl radical,
   or
R^{f} is an R² or R³ radical, with the proviso that at least one R^{f} radical is the R² radical, where
R² is a polyether radical of the formula VI

(F)_{q}[O(C₂H_{4-d}R′_{d}O)ₘ(CₓH₂ₓO)ᵣZ]_{w} (VI)

where
d is from 1 to 3,
m is ≧1,
q is 0 or 1,
x is from 2 to 10,
r is ≧0,
w is from 1 to 4,
F is a hydrocarbon radical which may also be branched,
R′ is a monovalent hydrocarbon radical which is aromatic or optionally also a substituted aromatic,
Z is a hydrogen atom or a monovalent organic radical such as alkyl or alkyl ester or aryl ester,
   and
R³ is a polyether radical of the formula VI

(F)_{q}[O(C₂H_{4-d}R′_{d}O)ₘ(CₓH₂ₓO)ᵣZ]_{w} (VI)

where
d is from 1 to 3,
m is ≧0,
q is 0 or 1,
x is from 2 to 10,
r is >1,
w is from 1 to 4,
F is a hydrocarbon radical which may also be branched,
R′ is a hydrogen radical, a monovalent hydrocarbon radical having from 1 to 18 carbon atoms,
Z is a hydrogen atom or a monovalent organic radical such as alkyl or alkyl ester or aryl ester,
   and where, in formula V,
b is from 0 to 8,
a is from 1 to 100 when b is from 6 to 8,
a is from 1 to 200 when b is from 3 to 6,
a is from 1 to 300 when b is from 0 to 3.

The values of a and b are understood to be average values, since the inventive silicone polyether copolymers are present in the form of generally equilibrated mixtures. Particular preference is given to those silicone polyether copolymers in which all R¹ radicals are methyl radicals.

The siloxane mixture may be straight-chain (b=0) or branched (b is from >0 to 8). Experience has shown that the value of ‘a’ can only be combined with values of ‘b’ in the manner specified, since the increased viscosity otherwise makes handling impossible.

It is known to a person skilled in the art that the above-described silicone polyethers can often have additional functional and nonfunctional groups, provided that such additional functional or nonfunctional groups do not interfere with the free-radical polymerization process. Examples are silicon-bonded acyloxy groups (acetoxy groups), hydroxyl groups and/or alkoxy groups (methoxy groups), but also substituents on the hydrocarbon groups bonded to silicon, for example, halogen atoms or alkoxy groups.

The monomers A may be homo- or copolymerized using any conventional synthetic method. For example, this may be solution polymerization, emulsion polymerization, reverse emulsion polymerization, suspension polymerization, reverse suspension polymerization or precipitation polymerization, without the usable methods being restricted thereto. The graft reaction may be effected in the presence or absence of solvents, if necessary also in biphasic or multiphasic systems. The only important prerequisite is the mutual solubility of the reactants in the medium. In solution polymerization, water, customary organic solvents or the inventive silicone derivatives B may themselves be used as the solvent. However, this latter process is preferred.

The graft reaction can be carried out under standard pressure, elevated pressure or reduced pressure, each of which are well known to those skilled in the art.

Any monomers, ethylenically unsaturated compound and any polymeric olefin having at least one radical of unsaturation (such as polymers of butadiene or isoprene or any type of macromonomers, including those which contain siloxane chains) are suitable for preparing the inventive graft copolymers.

The term ethylenically unsaturated means that the monomers A have at least one polymerizable carbon-carbon double bond which may be mono-, di-, tri- or tetra-substituted.

The preferred ethylenically unsaturated monomers may be described by the following general formula (I):

X—C(O)CR⁷═CHR⁶ (I)

where X is selected from the group of the —OH, —OM, —OR⁸, NH₂, NHR⁸, and N(R⁸)₂ radicals.

In the above formula, M is a cation selected from the group consisting of: Na⁺, K⁺, Mg⁺⁺, Ca⁺⁺, Zn⁺⁺, NH₄⁺, alkylammonium, dialkylammonium, trialkylammonium and tetraalkylammonium.

The R⁸ radicals may be selected identically or differently from the group consisting of —H, C₁-C₄₀ linear or branched-chain alkyl radicals, N,N-dimethylaminoethyl, 2-hydroxyethyl, 2-methoxyethyl, 2-ethoxyethyl, hydroxypropyl, methoxypropyl or ethoxypropyl.

R⁷ and R⁶ are each independently selected from the group consisting of: —H, C₁-C₈ linear or branched-chain alkyl chains, methoxy, ethoxy, 2-hydroxyethoxy, 2-methoxyethoxy and 2-ethoxyethyl.

Representative, but nonlimiting examples of suitable monomers are, for example, esters and amides.

The esters may be derived from C₁-C₄₀ linear, C₃-C₄₀ branched-chain or C₃-C₄₀ carbocyclic alcohols, from polyfunctional alcohols having from 2 to about 10 hydroxyl groups, such as ethylene glycol, hexylene glycol, glycerol and 1,2,6-hexanetriol, from amino alcohols or from alcohol ethers such as methoxyethanol and ethoxyethanol, or polyethylene glycols.

It has been found to be particularly advantageous to use monomers A which exist as copolymers of, in particular, ethyl acrylate, methyl acrylate, hydroxyethyl acrylate, n-butyl acrylate, lauryl acrylate, ethyl methacrylate, methyl methacrylate, hydroxyethyl methacrylate, n-butyl methacrylate and lauryl methacrylate.

Also suitable are N,N-dialkylaminoalkyl acrylates and methacrylates and N-dialkylaminoalkylacrylamides and -methacrylamides of the general formula (II)

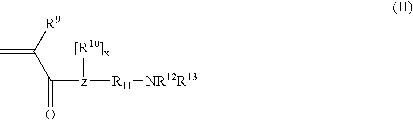

where
R⁹ is H, or an alkyl having from 1 to 8 carbon atoms,
R¹⁰ is H, or methyl,
R¹¹ is alkylene having from 1 to 24 carbon atoms, optionally substituted by alkyl,
R¹², R¹³ are a C₁-C₄₀-alkyl radical,
Z is nitrogen when x=1, or oxygen when x=0.

The amides may be unsubstituted, N-alkyl- or N-alkylamino-monosubstituted, or N,N-dialkyl-substituted or N,N-dialkylamino-disubstituted, where the alkyl or alkylamino groups are derived from C₁-C₄₀ linear, C₃-C₄₀ branched-chain or C₃-C₄₀ carbocyclic units.

Preferred monomers of the formula (II) are N,N-dimethylaminomethyl (meth)acrylate, N,N-diethylaminomethyl(meth)acrylate, N,N-dimethylaminoethyl (meth)acrylate, N,N-diethylaminoethyl(meth)acrylate and N,N-dimethylaminopropyl (meth)acrylate.

Monomers which are likewise usable are substituted acrylic acids and salts, esters and amides thereof, where the substituents on the carbon atoms are in the second or third position of the acrylic acid and are each independently selected from the group consisting of C₁-C₄-alkyl, —CN, and COOH, more preferably methacrylic acid derivatives, ethacrylic acid derivatives and 3-cyanoacrylic acid derivatives. These salts, esters and amides of these substituted acrylic acids may be selected as described above for the salts, esters and amides of acrylic acid.

Other suitable monomers are vinyl and allyl esters of C₁-C₄₀ linear, C₃-C₄₀ branched-chain or C₃-C₄₀ carbocyclic carboxylic acids (e.g., vinyl acetate, vinyl propionate, vinyl neononanoate, vinylneoundecanoic acid or vinyl t-butylbenzoate), vinyl or allyl halides, preferably vinyl chloride and allyl chloride, vinyl ethers, preferably methyl, ethyl, butyl or dodecyl vinyl ether, vinylformamide, vinylmethylacetamide, vinylamine, vinyllactams, preferably vinylpyrrolidone and vinylcaprolactam, vinyl- or allyl-substituted heterocyclic compounds, preferably vinylpyridine, vinyloxazoline and allylpyridine.

Also suitable are N-vinylimidazoles of the general formula (III) where R¹⁴ to R¹⁶ are each independently hydrogen, C₁-C₄-alkyl or phenyl:

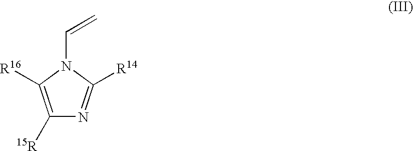

Further suitable monomers are diallylamines of the general formula (IV)

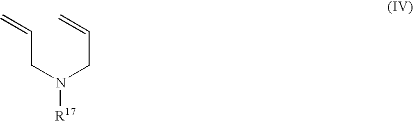

where
R¹⁷ is a C₁-C₂₄-alkyl.

Further suitable monomers are vinylidene chloride and hydrocarbons having at least one carbon-carbon double bond, preferably styrene, alpha-methylstyrene, tert-butylstyrene, butadiene, isoprene, cyclohexadiene, ethylene, propylene, 1-butene, 2-butene, isobutylene, vinyltoluene, and mixtures of these monomers. In addition to the above-mentioned monomers, the monomers used may be so-called macromonomers, for example silicone-containing macromonomers having one or more free-radically polymerizable groups or alkyloxazoline macromonomers, as described, for example, in EP-A-408 311.

In addition, fluorinated monomers, as described, for example, in EP-B-558 423, may be crosslinking compounds or molecular weight-regulating compounds in combination or alone.

The regulators used in the present invention include customary compounds known to those skilled in the art, for example, sulfur compounds (e.g., mercaptoethanol, 2-ethylhexyl thioglycolate, thioglycolic acid or dodecyl mercaptan), and tribromochloromethane or other compounds which have a regulating action on the molecular weight of the resulting polymers. If appropriate, it is also possible to use thiol-containing silicone compounds. However, preference is given to using silicone-free regulators and to adjusting the synthesis conditions such that no regulators need to be used.

The crosslinking monomers used may be compounds having at least two ethylenically unsaturated double bonds, for example, esters of ethylenically unsaturated carboxylic acids such as acrylic acid or methacrylic acid and polyhydric alcohols, ethers of at least dihydric alcohols, for example, vinyl ether or allyl ether. Also suitable are straight-chain or branched, linear or cyclic, aliphatic or aromatic hydrocarbons which bear at least two double bonds which are conjugated in the case of aliphatic hydrocarbons. Also suitable are amides of acrylic and methacrylic acid and N-allylamines of at least difunctional amines, for example 1,2-diaminoethane, 1,3-diaminopropane. Also suitable are triallylamine or corresponding ammonium salts, N-vinyl compounds of urea derivatives, at least difunctional amides, cyanurates or urethanes. Further suitable crosslinkers are divinyldioxane, tetraallylsilane or tetravinylsilane.

Particularly preferred crosslinkers are, for example, methylenebisacrylamide, triallylamine and triallylammonium salts, divinylimidazole, N,N′-divinylethyleneurea, reaction products of polyhydric alcohols with acrylic acid or methacrylic acid, methacrylic esters and acrylic esters of polyalkylene oxides or polyhydric alcohols which have been reacted with ethylene oxide and/or propylene oxide and/or epichlorohydrin. As is familiar to the person skilled in the art, the molecular weights can be adjusted such that no crosslinker is necessary.

Any combination of the monomers mentioned can be used in any mixing ratios. The sole prerequisite is their compatibility. In particular, it is also possible to select combinations in which the monomers have different reactivities and gradient copolymers are thus formed.

The inventive graft copolymers may contain any relative amounts of olefin grafted on the polyether siloxane. Preferred quantitative ratios vary depending on the use, as well as on the amount of styrene oxide in the graft base and are generally between 10 and 10 000% by weight of the particular underlying polyether siloxane.

A substance which forms free radicals under the reaction conditions is an essential prerequisite and constituent of the grafting operation to prepare the inventive graft copolymers. All agents which are suitable in principle for generating free radicals can be used, including but not exclusively, ionizing radiation, organic peroxy compounds, azo compounds and inorganic free-radical formers.

For better metering or compatibility of the free-radical formers, solvents which do not interfere with the free-radical polymerization may be used.

The temperature selected for the reaction depends upon the free-radical-forming compound used. When the free-radical formation is induced thermally, the half-life of decomposition of the primary particle plays a crucial role and can be selected such that a desired ratio of free radicals is always established in the reaction mixture. Suitable temperature ranges are between 30° C. and 225° C., and have an upper limit as a result of the thermal decomposition of the graft base.

The polyethers described in the formula VI are obtained by reacting a starter alcohol, which is preferably allyl alcohol or alkyl alcohol, by adding monomers thereon. Suitable monomers are ethylene oxide, propylene oxide, a compound from the group of tetrahydrofuran 1,2-epoxybutane (n-butylene oxide), 2,3-epoxybutane (isobutylene oxide), dodecyl oxide, and styrene oxide and/or methylstyrene oxide.

It is possible for the distribution of the monomers to be selected as desired, so that, for example, blocks may be present. It is also possible to use a mixture of monomers, so that polyethers are obtained in which the units are present in random distribution.

The radicals are introduced onto the molecule of the polysiloxane by addition to the SiH groups of the polysiloxane in the presence of a hydrosilylation catalyst or by the reaction of HO-functional polyether radicals with SiCl or SiH groups. According to the prior art, platinum, palladium or rhodium, amine or borane catalysts can be used.

The following examples are provided to illustrate the present invention and to demonstrate advantages that can be obtained from utilizing the inventive silicone-containing graft copolymers.

### REFERENCE EXAMPLE 1

### Preparation of a Styrene Oxide-Based Polyether:

Styrene oxide/ethylene oxide-containing block copolymer (MW=600, 70% EO content) was prepared. 58 g of allyl alcohol and KOH were initially charged in a pressure reactor and heated to 120° C. Subsequently, 120 g of styrene oxide were metered in over several hours and, after a postreaction time of 1 h, 440 g of ethylene oxide at 100° C. over several hours. After a further postreaction time of 1 h at 100° C. and cooling to 80° C., the reaction mixture was neutralized and transferred.

### REFERENCE EXAMPLE 2

### Preparation of a Styrene Oxide-Based Polyether

Ethylene oxide/styrene oxide-containing block copolymer (MW=600, 70% EO content) was prepared. 58 g of allyl alcohol and KOH were initially charged in a pressure reactor and heated to 100° C. Subsequently, 440 g of ethylene oxide were metered in over several hours and, after a postreaction time of 1 h, 120 g of styrene oxide at 120° C. over several hours. After a further postreaction time of 1 h at 120° C. and cooling to 80° C., the reaction mixture was neutralized and transferred.

### REFERENCE EXAMPLE 3

### Hydrosilylation of a Polysiloxane

A three-neck flask was initially charged with 2.6 mol of the polyether prepared in reference example 1 together with 1 mol of an α,ω-SiH siloxane (N=50, SiH=0.55) and 10 ppm of commercial platinum catalyst, which were heated to 90° C. with stirring. After 1 h of postreaction at 120° C., the clear product was distilled under an oil-pump vacuum (<5 mbar), filtered and transferred.

### REFERENCE EXAMPLE 4

### Hydrosilylation of a Polysiloxane

A three-neck flask was initially charged with 6.5 mol of the polyether prepared in reference example 2 together with 1 mol of a pendant-SiH siloxane (20.5/5, SiH=2.52) and 10 ppm of commercial platinum catalyst, which were heated to 90° C. with stirring. After 1 h of postreaction at 120° C., the clear product was distilled under an oil-pump vacuum (<5 mbar), filtered and transferred.

### EXAMPLE 1

### Reaction of an Ethylene Oxide/Styrene Oxide-Containing Silicone Polyether with Styrene Using Trigonox® 117 as an Initiator.

100 g of silicone polyether according to reference example 4 were heated to 140° C. in a four-neck flask equipped with stirrer, intensive cooler, thermometer and dropping funnel under a nitrogen atmosphere. Once the temperature had been attained, 20 g of styrene and 1.8 g of Trigonox 117 were added dropwise within 60 minutes, in the course of which an exothermic reaction was observed. The reaction mixture was then kept at 150° C. for one hour. Subsequently, using a distillation apparatus, residual monomers were distilled off at 145° C. and with an oil-pump vacuum. A colorless, clear product was obtained. The ¹H NMR spectrum of the product showed that the benzylic position on the polyether (8=4.7-4.9 ppm) had been grafted preferentially.

### EXAMPLE 2

### Reaction of an Ethylene Oxide/Styrene Oxide-Containing Silicone Polyether with BMA Using Trigonox® B as an Initiator.

100 g of silicone polyether according to reference example 1 were heated to 160° C. in a four-neck flask equipped with stirrer, intensive cooler, thermometer and dropping funnel under a nitrogen atmosphere. Once the temperature had been attained, 20 g of BMA and 3.6 g of Trigonox B were added dropwise within 60 minutes, in the course of which an exothermic reaction was observed. The reaction mixture was then kept at 160° C. for one hour. Subsequently, using a distillation apparatus, residual monomers were distilled off at 145° C. and with an oil-pump vacuum. A yellowish, clear product was obtained. The ¹H NMR spectrum of the product showed that the benzylic position on the polyether (6=4.7-4.9 ppm) had been grafted preferentially.

### EXAMPLE 3

### Reaction of an Ethylene Oxide/Styrene Oxide-Containing Silicone Polyether with Butyl Acrylate Using Trigonox® D-C50 as an Initiator.

100 g of silicone polyether according to reference example 1 were heated to 140° C. in a four-neck flask equipped with stirrer, intensive cooler, thermometer and dropping funnel under a nitrogen atmosphere. Once the temperature had been attained, 20 g of butyl acrylate and 5.4 g of Trigonox 201 were added dropwise within 60 minutes, in the course of which an exothermic reaction was observed. The reaction mixture was then kept at 150° C. for one hour. Subsequently, using a distillation apparatus, residual monomers were distilled off at 145° C. and with an oil-pump vacuum. A yellowish, clear product was obtained. The ¹H NMR spectrum of the product showed that the benzylic position on the polyether (6=4.7-4.9 ppm) had been grafted preferentially.

### EXAMPLE 4

### Reaction of an Ethylene Oxide/Styrene Oxide-Containing Silicone Polyether with Methacrylate and Methyl Methacrylate Using Perkadox® 16 as an Initiator.

100 g of silicone polyether according to reference example 1 were heated to 82° C. in a four-neck flask equipped with stirrer, intensive cooler, thermometer and dropping funnel under a nitrogen atmosphere. Once the temperature had been attained, 20 g of a 1:1 mixture of methacrylate and methyl methacrylate and 5.4 g of Perkadox 16 were added dropwise within 60 minutes, in the course of which an exothermic reaction was observed. The reaction mixture was then kept at 100° C. for one hour. Subsequently, using a distillation apparatus, residual monomers were distilled off at 150° C. and with an oil-pump vacuum. A colorless, clear product was obtained. The ¹H NMR spectrum of the product showed that the benzylic position on the polyether (δ=4.7-4.9 ppm) had been grafted preferentially.

These products were tested for performance in the ASTM 892 foam test. Also tested was the air release capacity by the impinger method. The products prepared in accordance with the invention were compared with grafted silicone polyethers whose polyethers have been formed only from ethylene oxide and propylene oxide. The oil formulation used was a mineral oil which comprised all additives apart from the defoamer. The defoamer was used at 20 ppm.

Results in the foam test to ASTM 892 in a mineral oil:

| | | | Test 1 | Test 2 |
|---|---|---|---|---|
| | Test 1 | Test 2 | (at 25° C.) | (at 93° C.) after |
| Defoamer | (at 25° C.) | (at 93° C.) | after 3 months | 3 months |
| Mineral oil | 500 ml of | 90 ml of foam | 520 ml of | 100 ml of |
| without | foam | decomposition | foam | foam |
| defoamer | decomposition time | time | decomposition | decomposition |
| | 312 seconds | 23 seconds | time | time |
| | | | >300 seconds | 30 seconds |
| Mineral oil | 50 ml of foam | 30 ml of foam | 80 ml of foam | 65 ml of foam |
| with 20 ppm | decomposition | decomposition | decomposition | decomposition |
| of acrylate | time | time | time | time |
| defoamer | 5 seconds | 0 second | 20 seconds | 11 seconds |
| Mineral oil | 0 ml of foam | 0 ml of foam | 200 ml of | 85 ml of foam |
| with 20 ppm | decomposition | decomposition | foam | decomposition |
| of randomly | time | time | decomposition | time |
| grafted | 0 second | 0 second | time | 21 seconds |
| silicone | | | 86 seconds | |
| polyether | | | | |
| Mineral oil | 0 ml of foam | 0 ml of foam | 0 ml of foam | 0 ml of foam |
| with 20 ppm | decomposition | decomposition | decomposition | decomposition |
| of inventive | time 0 second | time | time | time |
| grafted | | 0 second | 0 second | 0 second |
| silicone | | | | |
| polyether | | | | |
| from example 4 | | | | |

While the invention has been described herein with reference to specific embodiments, features and aspects, it will be recognized that the invention is not thus limited, but rather extends in utility to other modifications, variations, applications, and embodiments, and accordingly all such other modifications, variations, applications, and embodiments are to be regarded as being within the spirit and scope of the invention.

What is claimed is:

1. A copolymer prepared by grafting ethylenically unsaturated compounds A onto silicone polyethers B which consist of a silicone moiety and a polyether moiety which bears at least one styrene oxide unit as a chain constituent in the presence of an agent which produces free radicals.

2. The copolymer as claimed in claim 1, wherein the silicone polyethers B used as the graft base are described by formula V 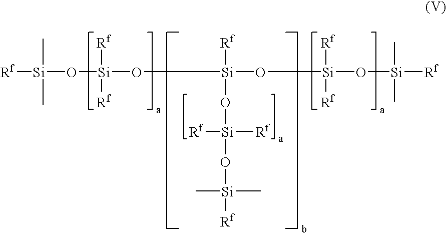
where
R^{f} may be an R¹ radical, and
R¹ is an alkyl radical having from 1 to 16 carbon atoms or an aryl radical,
or
R^{f} is an R² or R³ radical, with the proviso that at least one R^{f} radical is the R² radical, where
R² is a polyether radical of the formula VI
(F)_{q}[O(C₂H_{4-d}R′_{d}O)ₘ(CₓH₂ₓO)ᵣZ]_{w} (VI)
where
d is from 1 to 3,
m is ≧1,
q is 0 or 1,
x is from 2 to 10,
r is ≧0,
w is from 1 to 4,
F is a hydrocarbon radical which may also be branched,
R′ is a monovalent hydrocarbon radical which is aromatic or optionally also a substituted aromatic,
Z is a hydrogen atom or a monovalent organic radical such as alkyl or alkyl ester or aryl ester,
and
R³ is a polyether radical of the formula VI
(F)_{q}[O(C₂H_{4-d}R′_{d}O)ₘ(CₓH₂ₓO)ᵣZ]_{w} (VI)
where
d is from 1 to 3,
m is ≧0,
q is 0 or 1,
x is from 2 to 10,
r is >1,
w is from 1 to 4,
F is a hydrocarbon radical which may also be branched,
R′ is a hydrogen radical, a monovalent hydrocarbon radical having from 1 to 18 carbon atoms,
Z is a hydrogen atom or a monovalent organic radical,
and where, in formula V,
b is from 0 to 8, and
a is from 1 to 100 when b is from 6 to 8, or
a is from 1 to 200 when b is from 3 to 6, or
a is from 1 to 300 when b is from 0 to 3.

3. The copolymer according to claim 2, wherein all R¹ radicals are methyl radicals.

4. The copolymer as claimed in claim 1, wherein the ethylenically unsaturated compounds A are ethylenically unsaturated monomers.

5. The copolymer as claimed in claim 1, wherein the ethylenically unsaturated compounds A are a mixture of a plurality of ethylenically unsaturated monomers A.

6. The copolymer as claimed in claim 1, wherein the ethylenically unsaturated compounds A are polymeric olefins having at least one radical of unsaturation.

7. The copolymer as claimed in claim 1, wherein the ethylenically unsaturated compounds A are selected from a mixture of a plurality of ethylenically unsaturated monomers A and polymeric olefins having at least one radical of unsaturation.

8. The copolymer as claimed in claim 1, wherein between 2 and 500% by weight of the ethylenically unsaturated compounds A are polymerized in the presence of the silicone polyether.

9. The polymer as claimed in claim 1, wherein the ethylenically unsaturated monomers A are selected to an extent of from 2 to 100% by weight from the group of the derivatives of acrylic acid and methacrylic acid, vinyl ethers, vinyl alcohols, vinyl esters, styrene, derivatives of styrene, and mixtures of these monomers.

10. The polymer as claimed in claim 9, wherein the derivatives of acrylic acid and methacrylic acid are described by general formula I
R⁸O—C(O)CR⁷═CHR⁶ (I)
where
R⁷ and R⁶ are each independently selected from the group consisting of: —H, C₁-C₈ linear or branched-chain alkyl chains, methoxy, ethoxy, 2-hydroxyethoxy, 2-methoxyethoxy and 2-ethoxyethyl,
R⁸ is C₁-C₄₀ linear, C₃-C₄₀ branched-chain, aromatic or C₃-C₄₀ carbocyclic alcohols, polyfunctional alcohols having from 2 to about 10 hydroxyl groups, alcohol ethers, or polyethylene glycols.

11. The polymer as claimed in claim 1, wherein the ethylenically unsaturated monomers A are selected to an extent of from 2 to 100% by weight and are selected from the group of styrene, methylstyrene, tert-butylstyrene and other styrene derivatives, and from mixtures of these monomers.

12. The polymer as claimed in claim 1, wherein the ethylenically unsaturated monomers A are selected to an extent of from 2 to 100% by weight and are selected from the group of the vinyl and allyl esters of C₁-C₄₀ linear, C₃-C₄₀ branched-chain or C₃-C₄₀ carbocyclic carboxylic acids, vinyl or allyl halides, and from mixtures of these monomers.

13. A method of forming a copolymer comprising grafting ethylenically unsaturated compounds A onto silicone polyethers B which consist of a silicone moiety and a polyether moiety which bears at least one styrene oxide unit as a chain constituent in the presence of an agent which produces free radicals.

14. A method for defoaming or deaerating a nonaqueous system based on mineral oils or synthetic oils comprising adding a copolymer according to claim to said nonaqueous system.

15. The method as claimed in claim 13 wherein said copolymer is added in an amount below 150 ppm based on the oil components.

16. The method according to claim 15 wherein said copolymer is added in an amount between 10 and 100 ppm.

17. A nonaqueous system comprising at least one of a mineral oil and a synthetic oil and below 150 ppm of a copolymer according to claim 1.
